(19) United States
(12) Patent Application Publication
(10) Pub. No.: US 2024/0126946 A1
(43) Pub. Date: Apr. 18, 2024

(54) DESIGN SUPPORTING DEVICE AND DESIGN SUPPORTING METHOD

(71) Applicant: Hitachi, Ltd., Tokyo (JP)

(72) Inventors: Yuki ITABAYASHI, Tokyo (JP); Yuuki SHIMIZU, Tokyo (JP)

(73) Assignee: Hitachi, Ltd., Tokyo (JP)

(21) Appl. No.: 18/461,849

(22) Filed: Sep. 6, 2023

(30) Foreign Application Priority Data
Oct. 11, 2022 (JP) 2022-163075

(51) Int. Cl. G06F 30/20

(52) U.S. Cl. CPC G06F 30/20; G06F 2119/18

(57) ABSTRACT

To provide a design supporting device and a design supporting method capable of presenting a specific improvement plan for solving evaluation indexes having a trade-off relationship. The design supporting device comprises: an input unit which inputs a plurality of evaluation indexes and attribute information; a retrieval unit which acquires information on cases for improvement cases using the input information; a priority order calculation unit which prioritizes the cases; and an output unit which prioritizes cases for improvement plans of evaluation indexes being in a trade-off relationship and presents the same to the outside.

### CLAIM OF PRIORITY

The present application claims priority from Japanese Patent application serial no. 2022-163075, filed on Oct. 11, 2022, the content of which is hereby incorporated by reference into this application.

### BACKGROUND OF THE INVENTION

The present invention relates to a design supporting device and a design supporting method which support consideration of product design plans.

In product design, it is necessary to examine design plans which satisfy a plurality of evaluation indexes such as product performance, cost, and reliability on the basis of customer requirements. However, among the evaluation indexes, there are some evaluation indexes having a trade-off relationship with each other. For example, if the plate thickness is increased in order to increase the strength of a part, the cost and weight which are originally intended to be as small as possible will increase. In order to satisfy all the evaluation indexes, it is necessary to resolve the trade-off relationship as described above.

The method of TRIZ (Russian: Teoriya Resheniya Izobretatelskikh Zadatch: Inventive Problem Solving Theory) is generally known as a method for supporting ideas such as structures and functions which solve the trade-off relationship of evaluation indexes. TRIZ is a theory which systematizes the point of view of ideas for innovative problem solving and a thinking process, based on a statistical analysis of a huge amount of patent data and technical literatures of about 2 million items. In TRIZ, for each combination of evaluation indexes having a trade-off relationship, an invention principle being an idea to solve the trade-off relationship is presented.

Further, according to Japanese Unexamined Patent Application Publication No. 2019-125389, with the aim of supporting the creation of innovation by effectively presenting a solution concept to a user, it has been proposed that there is provided a “problem-solving support system characterized by having: basic information acquiring means to acquire basic information input by the user; and search means to search for one or more solution concepts, on the basis of three or more stages of degrees of relation between the reference character strings corresponding to the character strings of the basic information acquired by the basic information acquiring means and the solution concepts, by using three or more stages of degrees of relation between each reference character string acquired in advance and each solution concept classified into two or more types.

### SUMMARY OF THE INVENTION

Japanese Unexamined Patent Application Publication No. 2019-125389 is an invention which effectively presents a problem-solving concept to a user, thereby leading to the creation of innovation. However, in TRIZ and the known technology described in Japanese Unexamined Patent Application Publication No. 2019-125389, the presented solution concept and inventive principle are abstract. Therefore, the user's skill, experience and knowledge are separately required to materialize according to the design target.

For example, representative examples of the inventive principle include “copying substitution” and “low cost and low durability”, or the like. Each has a meaning such as “replacing with cheap ones, copying”, “use disposable or free materials”. However, if this is applied when newly designing heat radiation fins or fan blades or the like as applications for cooling the inside of a device, for example, the user sometimes gets lost in deciding what kind of design plan should be made.

With the above foregoing in view, an object of the present invention is to provide a design supporting device and a design supporting method capable of presenting a specific improvement plan for solving evaluation indexes having a trade-off relationship.

According to the above, this invention provides “a design supporting device comprising: an input unit which inputs a plurality of evaluation indexes and attribute information; a retrieval unit which acquires information on cases for improvement cases using the input information; a priority order calculation unit which prioritizes the cases; and an output unit which prioritizes cases for improvement plans of evaluation indexes being in a trade-off relationship and presents the same to the outside.”

Further, this invention provides “a design supporting method comprising the steps of: acquiring information on a case for a corresponding improvement case using a plurality of evaluation indexes and attribute information; performing prioritization on the case; and prioritizing and presenting cases for improvement plans of evaluation indexes being in a trade-off relationship.”

According to the present invention, specific improvement plans which solve evaluation indexes having a trade-off relationship are presented so that design plans which satisfy the evaluation indexes can be efficiently considered. Further, it is possible to efficiently support design without its turn by presenting the suggested improvement plans in descending priority order.

### BRIEF DESCRIPTION OF THE DRAWINGS

FIG. 1 is a view showing a configuration example of a design supporting device according to an embodiment of the present invention;

FIG. 2 is a view showing an example of a table structure of a case database;

FIG. 3 is a flowchart showing a processing procedure for a design supporting method according to an embodiment of the present invention;

FIG. 4 is a view showing an example of an input screen;

FIG. 5 is a view showing an example of the result of calculating a contribution degree and similarity, and scores of priority orders;

FIG. 6 is a view showing an example of the result of sorting prioritized scores in descending order; and

FIG. 7 is a view showing an example of an output screen using the present device.

### DETAILED DESCRIPTION OF THE PREFERRED EMBODIMENTS

The following case will hereinafter be described as a specific example of a design supporting device of the present invention with reference to the accompanying drawings. First, representative examples which present improvements for solving the trade-off relationship are shown as first and second embodiments. The present embodiment will be described taking as an example that with a CAD model of each cooling fin as a target, the trade-off relationship between evaluation indexes “improvement in cooling performance” and “reduction in manufacturing cost” is reconciled to present a design plan for “cooling fins” that satisfies the evaluation indexes.

### First Embodiment

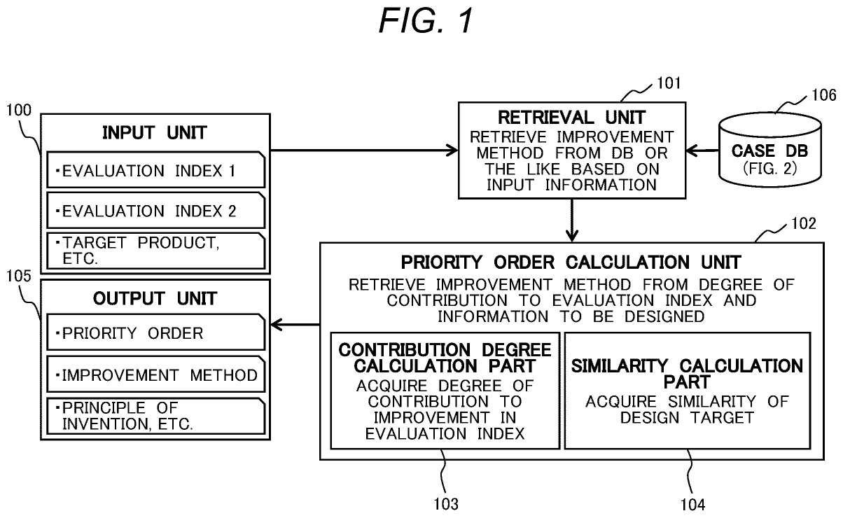

FIG. 1 is a view showing a configuration example of a design supporting device according to a first embodiment of the present invention. The design supporting device presents an improvement plan to a user to support the idea of the user.

The design supporting device of FIG. 1 includes an input unit 100, a case database 106, a retrieval unit 101, a priority order calculation unit 102, and an output unit 105. Further, the priority order calculation unit 102 includes a contribution degree calculation part 103 and a similarity calculation part 104.

Of these, the input unit 100 receives from the user as a retrieval condition, the input of attribute information such as evaluation indexes being in the relationship of trade-off desired to improve, the name of the product/part to be designed, a product function, and the classification of environment, quality, cost, deadline, etc. related to the evaluation indexes. In the illustrated example, it is assumed that evaluation indexes 1 and 2 as the evaluation indexes being in the trade-off relationship desired to be improved, and information on target products, etc. are input as input information (retrieval conditions).

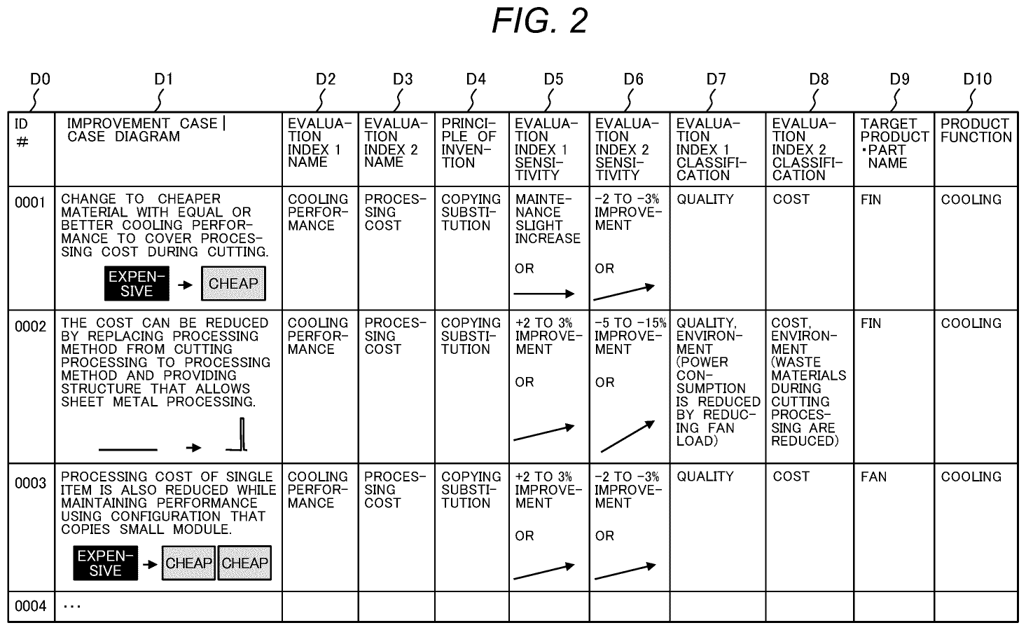

The retrieval unit 101 refers to the case database 106 based on the input information from the input unit 100 to extract an improvement plan for the trade-off relationship by retrieval, and outputs the same to the priority order calculation unit 102. The essential retrieval conditions for retrieval here are evaluation indexes having a trade-off relationship. It is assumed that there are stored in FIG. 2, cases of cooling fins in which the evaluation index 1 is an “improvement in cooling performance” and the evaluation index 2 is a “reduction in manufacturing cost”.

The case database 106 that stores multiple sets of improvement plans for the trade-off relationship in advance is constituted of data in the table structure of FIG. 2. The case database 106 is configured to include information such as an ID (D0), an improvement case D1, an evaluation index 1 name D2, an evaluation index 2 name D3, an inventive principle D4, an evaluation index 1 sensitivity D5, an evaluation index 2 sensitivity D6, an evaluation index 1 classification D7, an evaluation index 2 classification D8, a target product/part name D9, a product function D10, etc.

Of these, the ID (D0) is an identifier assigned to each design case. The improvement case D1 is described as a specific improvement plan. The evaluation index 1 name D2 and the evaluation index 2 name D3 are evaluation indexes to be improved having a trade-off relationship and are evaluation indexes that have been improved by the improvement plan D1.

Characteristic items of the data held in the case database 106 according to the present invention are that they have the evaluation index 1 sensitivity D5 and the evaluation index 2 sensitivity D6. The evaluation index 1 sensitivity D5 and the evaluation index 2 sensitivity D6 store improvement effects by the improvement plan D1 in a format that allows qualitative or qualitative comparison of the improvement effects.

In the case where the ID (D0) of the case in FIG. 2 is #0001, there is described as the improvement case D1 that “change to a cheaper material with equal or better cooling performance, to cover the cost of processing during cutting”. “Cooling performance” and “processing cost” are described in the columns of the evaluation index 1 name D2 and the evaluation index 2 name D3 respectively, and “copying substitution” is described in the inventive principle D4. A value indicating the degree of improvement in the cooling performance by the improvement case D1 is approximately 0 and described in the column of the evaluation index 1 sensitivity D5 as “maintenance, slight increase” taken as the term that means it. “−2% to −3% improvement” is described in the subsequent column of evaluation index 2 sensitivity as a value indicating the degree of improvement in the processing cost by the improvement case D1.

The cooling performance of the evaluation index 1 name D2 is defined as “quality” in the evaluation index 1 classification D7. The processing cost of the evaluation index 2 name D3 is defined as “cost” in the evaluation index 2 classification D8. In such classifications, for example, they can be defined from the viewpoint of EQCD such as environment, quality, performance, cost, and deadline from the viewpoint of quality assurance. The target product/part name D9 is represented as “fin”, and the product function D10 is represented as “cooling”. It should be noted that the evaluation index 1 sensitivity D5 and the evaluation index 2 sensitivity D6 may be visualized so that they can be intuitively recognized by indicating the value indicating the degree of improvement with an arrow as an inclination.

In the case where the ID (D0) of the case in FIG. 2 is #0002, there is described as the improvement case D1 that “the cost can be reduced by replacing a processing method from cutting processing to a processing method and providing a structure that allows sheet metal processing”. In the case of #0003, there is described an improvement case that “the processing cost of a single item is also reduced while maintaining the performance by using a configuration that copies a small module”. Even in these cases, the improvement effects by the improvement plan D1 are stored in the evaluation index 1 sensitivity D5 and the evaluation index 2 sensitivity D6 in a format that allow qualitative or qualitative comparison of the improvement effects. The quantitative effect is described by a numerical value such as “+2% to −3% improvement”, “−5% to −15% improvement” or the like, or the degree of improvement is qualitatively described by the inclination of the arrow and the notation of large, medium, and small effects.

As described above, the format that enables qualitative or quantitative comparison of the improvement effects by the improvement plan is a format that qualitatively or quantitatively expresses how much a certain problem is improved or deteriorated in each improvement. In the present embodiment, each improvement plan is expressed by “%” or “good and/or bad”, but is not limited to or by these.

Returning to FIG. 1, the contribution degree calculation part 103 acquires the degree of improvement of each evaluation index having the trade-off relationship as the degree of contribution with the design case retrieved from the case database 106 as a target, and calculates a larger degree of improvement so that the degree of contribution increases.

Here, the information handled by the contribution degree calculation part 103 is basically information of each case extracted from the match retrieval of the data content of the case database 106 for the reason that all input items match. In this case, the extracted cases are assumed to be limited and few. For this reason, in the retrieval for the contribution degree calculation part 103, it is better to generate related terms for the input terms, and to perform retrieval including these terms.

Further, the similarity calculation part 104 acquires the similarity of attribute information of evaluation indexes having a trade-off relationship with the design case retrieved from the case database 106 as the target in the same manner as the contribution degree calculation part 103, to thereby calculate similar ones so that the similarity becomes high.

Here, the information handled by the similarity calculation part 104 is basically information of each case extracted from the match retrieval of the case database 106 for the reason that some of the input items match. For example, when the input is five items, a case where the three items match is extracted together with information on a match rate. Alternatively, the similarity may be determined from the viewpoint of similar technology.

Using the above-described results of the contribution degree calculation part 103 and the similarity calculation part 104, the priority order calculation unit 102 calculates the priority order of the improvement plans for the evaluation indexes so that those having a high degree of contribution and a high degree of similarity become high in priority order as well. The output unit 105 outputs a result of sorting the improvement plans in the order of descending priorities.

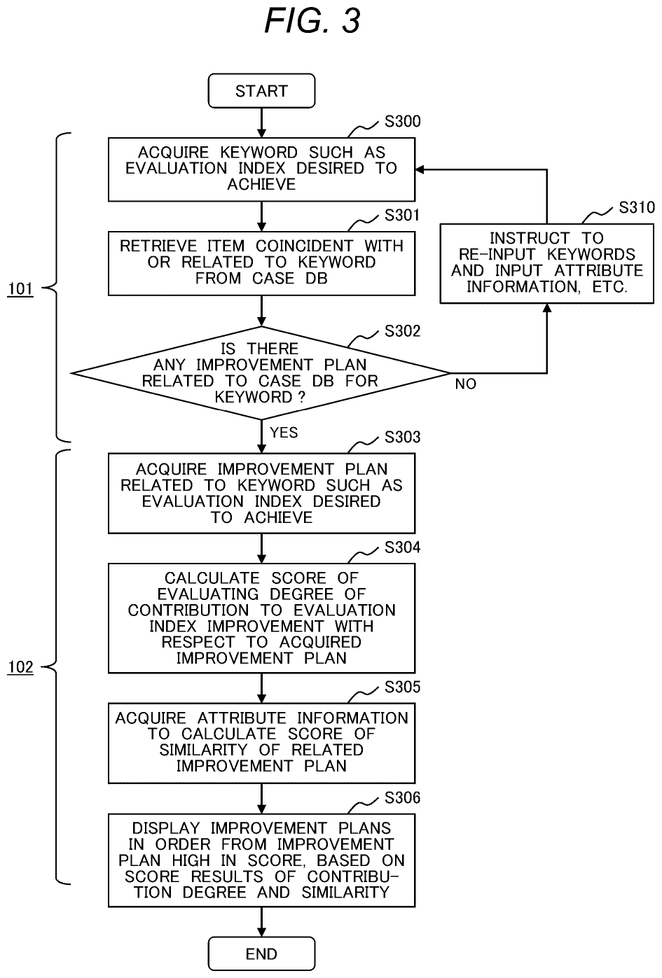

FIG. 3 is a flowchart explaining an example of the flow of a processing procedure except for the input unit 100 and the output unit 105. According to the flow of FIG. 3, the retrieval unit 101 first acquires each of keywords such as evaluation indexes (D2 and D3) to be achieved being in a trade-off relationship, which are received from the input unit 100 (processing step S300). At this time, attribute information and the like are included in the items other than the keywords of the evaluation indexes (D4 to D10).

Next, an improvement plan that matches or is similar to the acquired keyword is retrieved from the case database 106 (processing step S301). At this time, when a keyword retrieval is used, a natural language processing technology such as a morphological analysis, Word2Vec or the like may be utilized.

In a processing step S302, it is checked whether there is an improvement plan related to the case database 106. When there is an improvement plan, the processing procedure proceeds to the next processing step S303. On the other hand, when there is no improvement plan, the user instructs to re-input the keyword entered in the input unit 100 or input the attribute information in a processing step S310.

After the processing step S303, the processing of the priority order calculation unit 102 is conducted. First, the priority order calculation unit 102 acquires an improvement plan related to the keyword in the processing step S310 as a result of the retrieval unit 101.

Next, two processing are carried out. Specifically, the processing of the contribution degree calculation part 103 (processing step S304) and the processing of the similarity calculation part 104 (processing step S305) are executed. The details of the respective calculation formulas and processing contents will be described later.

Returning to FIG. 1, the contribution degree calculation part 103 calculates a contribution degree for the improvement plan acquired as shown in the processing step S304 by utilizing the data of the evaluation index 1 sensitivity D5 and the evaluation index 2 sensitivity D6 being the values indicating the improvement degrees of the evaluation indexes that are in the trade-off relationship. The contribution degree is determined by the following formula (1). Incidentally, u₁ is the sensitivity of the evaluation index 1, u₂ is the sensitivity of the evaluation index 2, and K is the degree of contribution to the improvement plan.

K=u₁+u₂ (1)

As information related to the formula (1), the data stored in the past case database 106 is used for the evaluation index 1 sensitivity D5 and the evaluation index 2 sensitivity D6. Specifically, the rate improved from past cases and a correlation coefficient that indicates the tendency to improve from past results, etc. are stored as numerical values. The range of the values is defined within the range of ±1.0 to 0.0. It means that the closer the value is to 1.0, the higher the degree of contribution. The degree of contribution of each improvement plan is calculated based on the sensitivity of each evaluation index. This evaluation is applicable when the degree of improvement is quantitatively grasped by the numerical values.

On the other hand, in the evaluation index 1 sensitivity D5 and the evaluation index 2 sensitivity D6, as indicated by the arrows, the degree of improvement may be qualitatively grasped like the inclination of the arrow or large, medium or small. In such a case, it is possible to deal with this situation in the same manner by performing numerical conversion according to the inclination, or by converting large, medium, and small to numerical values such as 0.8, 0.5, and 0.2, respectively.

Next, the similarity calculation part 104 utilizes the data of the target product/part name D9 and the product function D10, which are input as attribute information to calculate similarity for the acquired improvement plan as shown in the processing step S305. The similarity is determined by the following formula (2). Incidentally, tp is the similarity of the target product/part name, f is the similarity of the product function, n is the number of items of the target product/part name and product function, and R is the similarity of the improvement plan.

$$R = ( \frac{tp + f}{n} ) \qquad ( 2 )$$

As information about the formula (2), the similarity between the keyword received by the input unit 100 and the keyword of the data stored in the case database 106 is calculated as a quantitative numerical value. When a keyword retrieval is utilized, the natural language processing technology such as the morphological analysis, Word2Vec or the like may be utilized. The similarity of each keyword is defined within the range of 0.0 to 1.0. It means that the closer the value is to 1.0, the higher the similarity. Based on the similarity of each attribute information, the similarity with the name, function, etc., of the design target is calculated for each improvement plan.

The final priority order is determined by the following formula (3) based on the results of the formulas (1) and (2). Incidentally, K is the degree of contribution of an improvement plan, R is the similarity of the improvement plan, and Y is a score index for a priority order.

Y=K×R (3)

As described above, each of the indexes which serves as the prioritized score is calculated by multiplying the degree of contribution and the similarity. In other words, the score of the improvement plan which is high in the degree of contribution and similarity becomes high. When the user wants to place importance on the degree of contribution, it is also possible to add a weight.

As described above, based on the acquired prioritized scores, the priority order calculation unit 102 ranks the improvement plans, and displays the improvement plans in descending order of scores thereof (processing step S306).

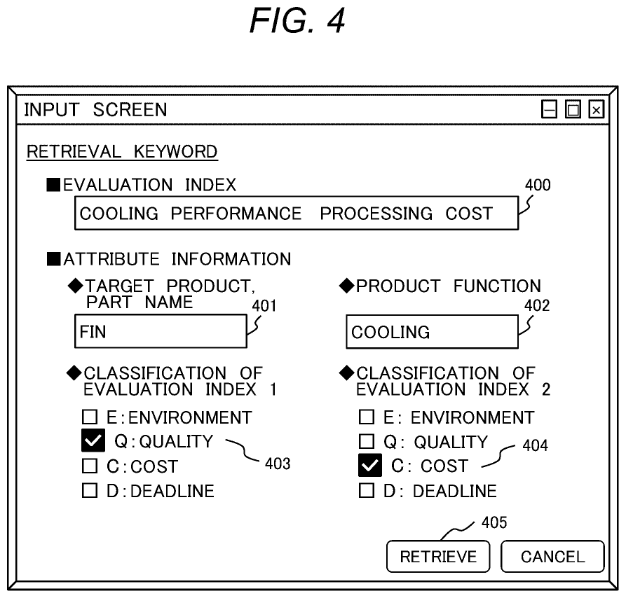

FIG. 4 is a view describing an example of an input screen. As a retrieval keyword, the user inputs, in the evaluation index entry field 400, the evaluation indexes having the trade-off relationship to be achieved, in a space delimited form. In the present embodiment, the evaluation indexes are input as “cooling performance” and “processing cost”. Next, the evaluation index is input to a target product/part name entry field 401 for attribute information as “fin”. Subsequently, the evaluation index is input to a product function entry field 402 as “cooling”. Finally, “quality” for the cooling performance and “cost” for the processing cost are input to an evaluation index 1 classification entry field 403 and an evaluation index 2 classification entry field 404. After completing the input of the keyword and attribute information, a retrieval button 405 is pressed to execute the retrieval.

In retrieving, D3 and D4 in the database structure of FIG. 2 are referenced by the data in the entry field 400, D9 is referenced by the data in the entry field 401, D10 is referenced by the data in the entry field 402, D7 is referenced by the data in the entry field 403, and D8 is referenced by the data in the entry field 404, so that the case numbers of cases where they hit are extracted. In the retrieval by the contribution degree calculation part 103, all items are matched, but in the retrieval by the similarity calculation part 104, the case number of the hit case is extracted together with information on the similarity ratio by partial matching.

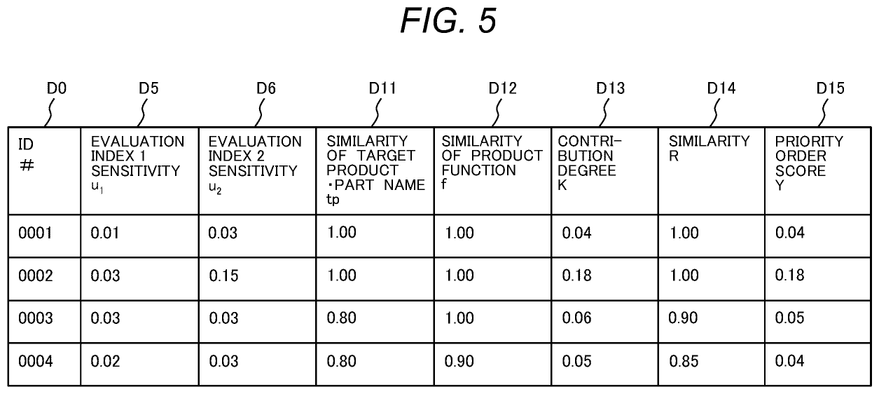

FIG. 5 is an example of the result of calculating a contribution degree and similarity, and scores of priority orders. Here, there are shown the results calculated on the conditions for the retrieval keyword entered in FIG. 4 with the data on the case database shown in FIG. 2 as the target. It is assumed that FIG. 5 shows a screen on which the retrieval and calculation results are displayed.

As the calculation results, an ID (D0), an evaluation index 1 sensitivity D5, an evaluation index 2 sensitivity D6, a target product/part name similarity D11, a product function similarity D12, a contribution degree D13, a similarity D14, and a priority order score D15 are calculated and displayed.

For example, in #0001, “0.01” is displayed as the evaluation index 1 sensitivity D5, and “0.03” is displayed as the evaluation index 2 sensitivity D6. Substituting the values into the formula (1), “0.04” is calculated and displayed as the contribution degree D13 for the improvement plan. Next, the similarity D14 becomes “1.0” when the retrieval keyword and the keyword of each item completely match. “1.00” is displayed as the target product/part name similarity D11, and “1.00” is displayed as the product function similarity D12.

Substituting these values into the formula (2), “1.00” is calculated for the similarity D14 of the improvement plans. Substituting the results of the formulas (1) and (2) into the formula (3), “0.04” is calculated for the priority order score D15. From the above, the priority order score for each ID can be calculated as “0.04” for #0001, “0.18” for #0002, “0.05” for #0003, and “0.04” for #0004.

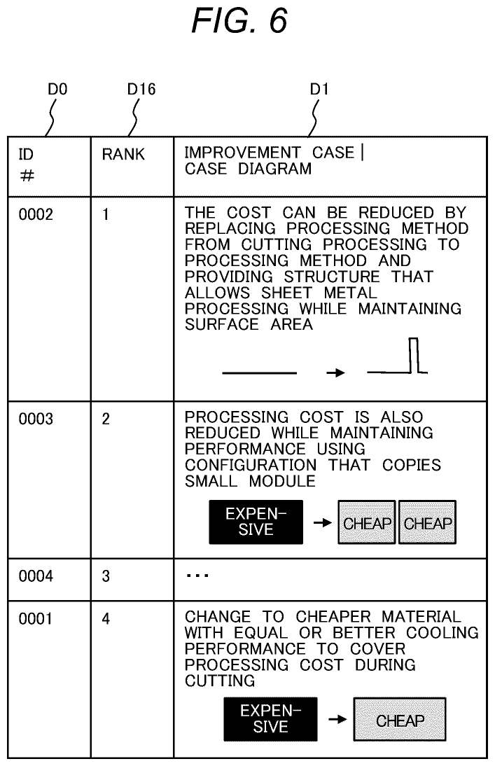

FIG. 6 is an example of the result of sorting prioritized scores in descending order. Based on the calculation result of FIG. 5, an ID (D0), a Rank (D16), and an improvement case (D1) are linked. If the ranking numbers are assigned in descending order of scores, the ranking can be sorted in the order of ID #0002, ID #0003, ID #0004, and ID #0001 from the high order.

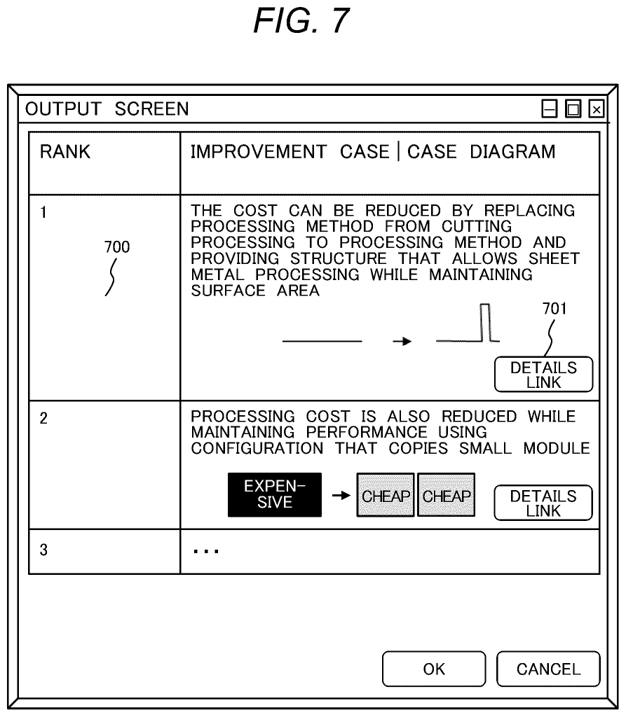

FIG. 7 is a view describing an example of an output screen. The results sorted in FIG. 6 are presented to the user. At this time, the user can refer to a specific case of improvement to improve the evaluation indexes being in the trade-off relationship entered on the input screen of FIG. 4 from an improvement plan 700 highest in priority order score that “the cost can be reduced by replacing a processing method from cutting processing to a processing method and making a structure that allows sheet metal processing while maintaining a surface area”. Also for information such as the inventive principle and attributes stored in the case database, the detailed contents of each improvement case can also be called up from the details link 701. Alternatively, if the related documents are set to be opened from the details link, it is possible to refer to a statement of design standards and technical documents related to the improvement cases.

### Second Embodiment

A second embodiment is similar in basic configuration to the first embodiment. Further, however, for each element for which the similarity is calculated, the similarity of the shape is calculated using the CAD model to be designed and the geometric information of the shape even in addition to the above-described similarity of target product/part name and product function.

As a method of determining the similarity, there is a method of evaluating the similarity of the geometric information of the shape and newly adding it to the item of the similarity in the formula (2). At this time, the similarity of the geometric information may be evaluated by partial shape recognition using, for example, a similar partial shape retrieval technique.

For example, when comparing “fin” and “fan” in the target product/part name, they are common except for the second letter, and the natural language processing technology will judge that they are high in similarity. However, by using the geometric information of the two shapes, it is considered that it is possible to correctly evaluate the similarity and present an improvement plan more suitable for the user's design target in these two shapes whose target shapes are completely different.

In addition, when visualizing groups with similar contents of improvement plans, it is desirable to be able to filter and switchably display the visualization form such that similar types of data are grouped and displayed.

Further, if there is no superiority or inferiority from the calculation results of the degree of contribution or similarity, it is preferable to add the items necessary for calculation, by instructing an input part to re-enter or add attribute information for inputting and calculate the priority order.

### REFERENCE SIGNS LIST

100: input unit
101: retrieval unit
102: priority order calculation unit
103: contribution degree calculation part
104: similarity calculation part
105: output unit
106: case database

What is claimed is:

1. A design supporting device comprising:
an input unit which inputs a plurality of evaluation indexes and attribute information;
a retrieval unit which acquires information on cases for improvement cases using the input information;
a priority order calculation unit which prioritizes the cases; and
an output unit which prioritizes cases for improvement plans of evaluation indexes being in a trade-off relationship and presents the same to the outside.

2. The design supporting device according to claim 1, including a database having a plurality of cases in each of which a plurality of evaluation indexes being in a trade-off relationship in design, an improvement case in which the trade-off relationship is capable of being improved, an evaluation index sensitivity in which each of the degrees of improvement of the evaluation indexes by the improvement case is qualitatively or quantitatively expressed to be comparable, and attribute information related to a design target are taken as a set,
wherein the retrieval unit acquires information on the corresponding case for the improvement case from the database using the input information.

3. The design supporting device according to claim 1, wherein the priority order calculation unit includes a contribution degree calculation part which calculates the degree of contribution according to the degree of improvement of the evaluation index.

4. The design supporting device according to claim 2, wherein the priority order calculation unit includes a similarity calculation part which calculates similarity from the input information and the similarity property of the information stored in the database.

5. The design supporting device according to claim 3, wherein the priority order calculation unit includes a similarity calculation part which calculates similarity from the input information and the similarity property of the information stored in the database, and performs prioritization from the contribution degree and the similarity.

6. The design supporting device according to claim 5, wherein the prioritization is performed according to the contribution degree and the similarity each given a weight, and the weight is made variable.

7. The design supporting device according to claim 4, wherein the similarity calculation part judges the similarity inclusive of the similarity properties of CAD models and shapes or the like.

8. The design supporting device according to claim 1, wherein the output unit includes a display part, and is capable of grouping and displaying similar types of improvement cases and highlight a visualization form in the display part.

9. The design supporting device according to claim 5, wherein when superiority or inferiority is not determined from the calculation results of the contribution degree or similarity, a message prompting a change of retrieval conditions is presented.

10. A design supporting method comprising the steps of:
acquiring information on a case for a corresponding improvement case using a plurality of evaluation indexes and attribute information;
performing prioritization on the case; and
prioritizing and presenting cases for improvement plans of evaluation indexes being in a trade-off relationship.

11. The design supporting method according to claim 10, wherein
a plurality of cases are included in each of which a plurality of evaluation indexes being in a trade-off relationship in design, an improvement case in which the trade-off relationship is capable of being improved, an evaluation index sensitivity in which each of the degrees of improvement of the evaluation indexes by the improvement case is qualitatively or quantitatively expressed to be comparable, and attribute information related to a design target are taken as a set, and
information on the case for the improvement case is acquired using the input information.

12. The design supporting method according to claim 10, wherein the degree of contribution is calculated according to the degree of improvement of the evaluation index.

13. The design supporting method according to claim 10, wherein the similarity is calculated from the evaluation indexes and the attribute information, and the similarity property of the held information.

14. The design supporting method according to claim 12, wherein the similarity is calculated from the evaluation indexes and the attribute information, and the similarity property of the information held, and prioritization is performed from the degree of contribution and the similarity.
